(19) United States
(12) Patent Application Publication
(10) Pub. No.: US 2007/0137688 A1
(43) Pub. Date: Jun. 21, 2007

(54) Photovoltaic power generator

(75) Inventor: Toshiya Yoshida, Saitama (JP)

Correspondence Address: NDQ&M WATCHSTONE LLP, 1300 EYE STREET, NW, SUITE 1000 WEST TOWER, WASHINGTON, DC, 20005, US

(73) Assignee: Tokyo Denki University, Tokyo (JP)

(21) Appl. No.: 10/578,434

(22) PCT Filed: Nov. 9, 2004
(86) PCT No.: PCT/JP04/16592

§ 371 Date: May 5, 2006

(30) Foreign Application Priority Data
Nov. 10, 2003 (JP) 2003-380566

(51) Int. Cl. H02N 6/00

(52) U.S. Cl. 136/244; 136/293

(57) ABSTRACT

A photovoltaic power generator which outputs power generated by a solar battery panel through a DC-DC converter detects a time point at which a time differentiation value of output voltage of the solar battery panel substantially becomes zero, obtains power variation from the output power of the solar battery panel at each time point, controls the DC-DC converter based on the power variation, thereby swiftly and precisely tracking the maximum power point of the solar battery panel even when hysteresis loop (dynamic characteristic) is generated.

### TECHNICAL FIELD

The present invention relates to a photovoltaic power generator using a solar battery.

### BACKGROUND ART

In order to efficiently generate electricity in a photovoltaic power generation system, a control method which tracks the best electrical operating point (maximum power point) of a solar battery panel, i.e., a maximum power point tracking (MPPT) control is necessary. A so-called hill-climbing method is known as such a control method. According to the hill-climbing method, an operating point at which the output power of a solar battery panel becomes maximum is explored by varying the electrical operating point.

FIG. 1 shows a general static characteristic of relationship between output current and output electricity of a solar battery panel. According to the hill-climbing method or a method similar to this, output powers (vertical axis) of two points are sampled by sweeping the output current (lateral axis) of the solar battery panel, and the maximum power point is explored based on a magnitude relation between the sampled values. For example, when powers at operating points a1 and a2 (exploring region Sa) shown in FIG. 1 are sampled, since the power at the point a2 is greater than that at the point a1, it is found that a maximum power point P_{M} exists on the side of the point a2 i.e., in a current increasing tendency. On the other hand, when the operating points c1 and c2 (exploring region Sc) are sampled, since the power at the point c1 is greater than the power at the point c2 it is found that the maximum power point P_{M} exists in a current reducing tendency. When powers at the operating points b1 and b2 (exploring region Sb) are sampled, since the powers at the both points are same, it is determined that the maximum power point P_{M} exists between the two points.

When power is taken out from a solar battery panel disposed on a roof of a house, since the variation in environment such as illumination amount and temperature is gentle, if the maximum power point is explored every few minutes and electrical operating point of a solar battery panel is renewed, it is expected that the power generating efficiency can be increased. It is unnecessary that the speed required for exploring the maximum power point is high, and the exploration is completed within seconds.

Conventional techniques relating to the present invention are disclosed in Japanese Patent Application Publication No. H5-68722, Japanese Patent Application Laid-open No. 2001-325031, “Micro-computer control of a residential photovoltaic power condition system”, B. K. Bose, P. M. Szczensny and R. L. Steigerwald, IEEE Transactions on Industrial Application, Vol. IA-21, PP. 1182-1191 (1985), and “Maximum Power Control for a Photovoltaic Power Generation System by Adaptive Hill-climbing Method”, Kenji Takahara, Youichi Yamanouchi, and Hideki Kawaguchi, The Institute of Electrical Engineers of Japan, Journal D, Vol. 121, No. 6, PP. 689-694 (2001).

### DISCLOSURE OF THE INVENTION

When a photovoltaic power generator is disposed in a moving object such as a solar-powered vehicle, since the power generating condition is largely varied and the maximum power point is also varied, it is necessary to always explore the maximum power point. It is also necessary to shorten the time during which the varied maximum power point is explored. In order to shorten the time during which the varied maximum power point is explored, it is necessary to vary the electrical operating point quickly and to explore the maximum power point. However, if the operating point of the solar battery is varied quickly, a dynamic characteristic appears due to influence of lifetime of a carrier in the solar battery that is different from the static characteristic shown in FIG. 1. If the electrical operating point is quickly varied in the vicinity of the maximum power point, a relationship between the output current and the output power describes a hysteresis curve Lh as shown in FIG. 2. In a general solar battery panel, this phenomenon appears remarkably in a frequency region over a few hundred Hz. In such a case, the power on the static characteristic may not be sampled precisely by means of a normal maximum power point exploring method in some cases. Thus, there is a problem. that it is difficult to explore and specify a real maximum power point.

According to the present invention, it is possible to perform a rapid exploration of the maximum power point. As a result, even if the power generation condition is varied, it is possible to output the maximum power at any time.

According to a technical aspect of the invention, there is also provided a photovoltaic power generator which outputs power generated by a solar battery panel through a DC-DC converter, wherein the DC-DC converter is controlled and a maximum power condition of the solar battery panel is explored based on an output power of the solar battery panel at a time point at which time differentiation value of output voltage of the solar battery panel substantially becomes zero.

According to another technical aspect of the invention, there is also provided a control method of a photovoltaic power generator which outputs power generated by a solar battery panel through a DC-DC converter, wherein the method includes detecting a time point at which a time differentiation value of an output voltage of the solar battery panel substantially becomes zero, and controlling the DC-DC converter based on the output power of the solar battery panel at the detected time point to explore the maximum power condition of the solar battery panel.

### BRIEF DESCRIPTION OF THE DRAWINGS

FIG. 1 is a diagram showing a relationship between output current and output power of a solar battery panel in a static condition.

FIG. 2 is a diagram showing a hysteresis loop caused by dynamic characteristic of the solar battery panel.

FIG. 3 is a diagram showing a relationship between output voltage (V) and output power (P) of the solar battery panel in a static condition, and a relationship between the output voltage (V) and output current (I) of the solar battery panel in a static condition.

FIG. 4 is a diagram showing a configuration of a general photovoltaic power generator.

FIG. 5 is a diagram showing a manner where an operating point moves when the hysteresis loop appears.

FIG. 6 is a diagram of an equivalent circuit of the solar battery panel.

FIG. 7 is a diagram showing a configuration of the photovoltaic power generator according to the present invention.

FIG. 8 is a diagram showing a configuration of a controller of a photovoltaic power generator according to a first embodiment.

FIG. 9 is a diagram showing a configuration of a controller of a photovoltaic power generator according to a second embodiment.

FIG. 10 is a diagram showing an example of a configuration of a sign switch.

FIG. 11 is a diagram showing a configuration of a photovoltaic power generator according to a third embodiment.

FIG. 12 is a diagram showing response characteristic with respect to exploration frequency of the photovoltaic power generator of the third embodiment.

FIG. 13 is a diagram showing convergence of exploration condition of the photovoltaic power generator of the third embodiment to the maximum power point.

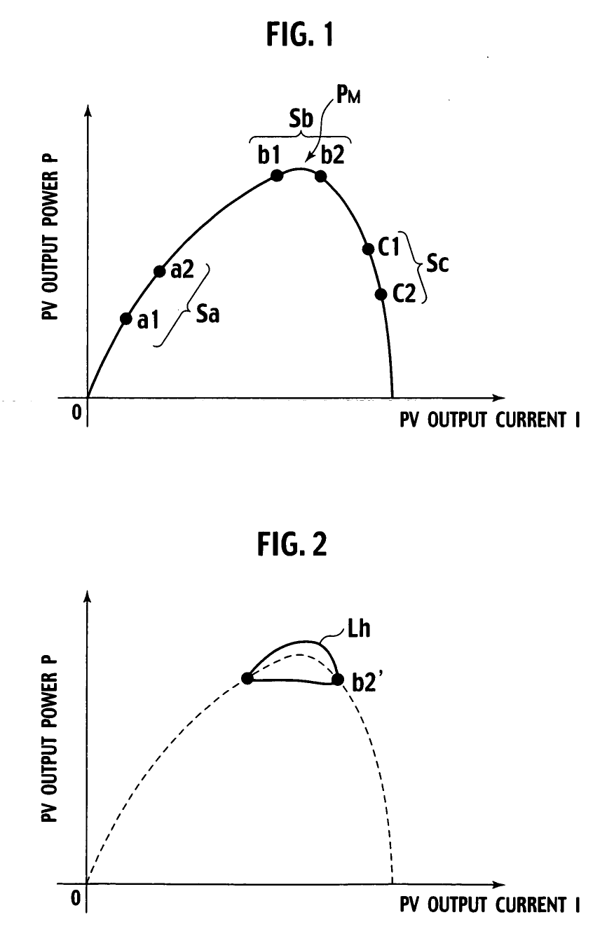

### BEST MODE FOR CARRYING OUT THE INVENTION

1. Maximum Power Point Tracking (MPPT) Control Method

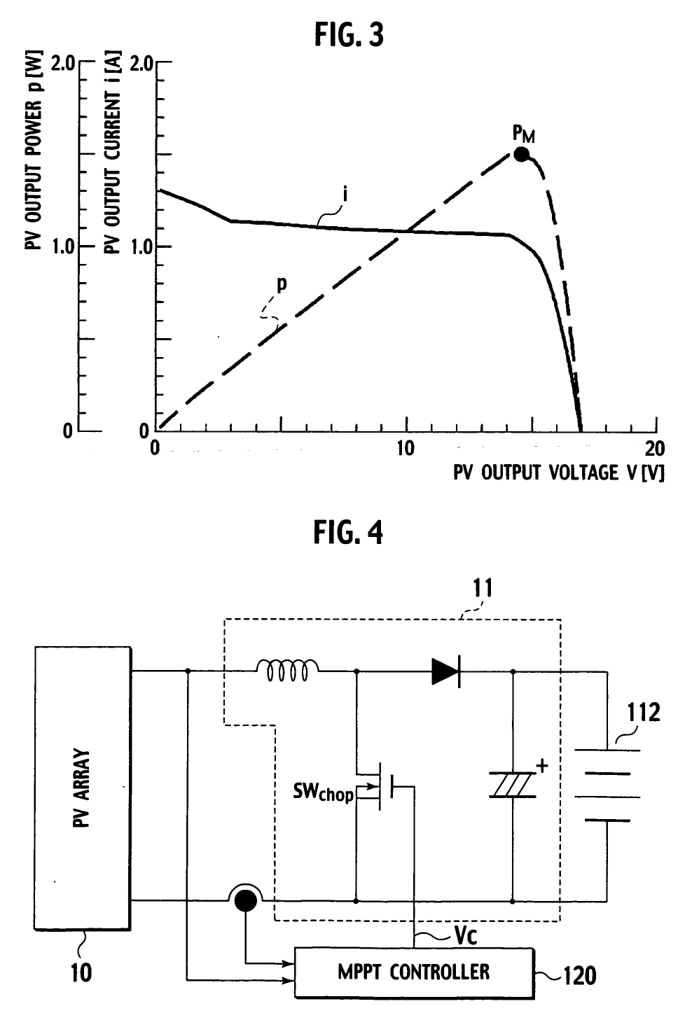

FIG. 3 shows, a typical static characteristic of a solar battery panel (PV) based on a relationship between current and voltage (I-V) and a relationship between electricity and voltage (P-V). A reference symbol P_{M} represents maximum output power of the solar battery panel. According to a normal maximum power point tracking method, generated power is sequentially measured for tracking the maximum output power point P_{M}, thereby obtaining gradient of P-V characteristics. A point at which the gradient becomes zero is the best operating point P_{M}. Therefore, the control is performed in such a way that the operating voltage of the solar battery panel is held when the gradient becomes zero. The operating voltage Vop is controlled such that the output voltage comes close to the best operating point based on the power variation of the solar battery panel.

The power variation Pdif is expressed by Pdif=P(Vop+ΔV)−P(Vop−ΔV), wherein P is the output power of the solar battery panel as a function of the output voltage V as shown in FIG. 3, and ΔV is an amplitude of a sweep signal for exploring the maximum power condition of the solar battery panel and has a positive value.

At that time, the operating voltage Vop is controlled such that (i) Vop is increased as Pdif is greater than zero, (ii) Vop is reduced as Pdif is smaller than zero, and (iii) Vop at the time is held as Pdif is equal to zero. The operating voltage Vop is adjusted by controlling the conduction ratio of the switching of a DC-DC converter 11 shown in FIG. 4 by means of control voltage Vc.

2. Principle of Maximum Power Point Tracking Control Method Adaptable to Dynamic Characteristic of a Solar Battery

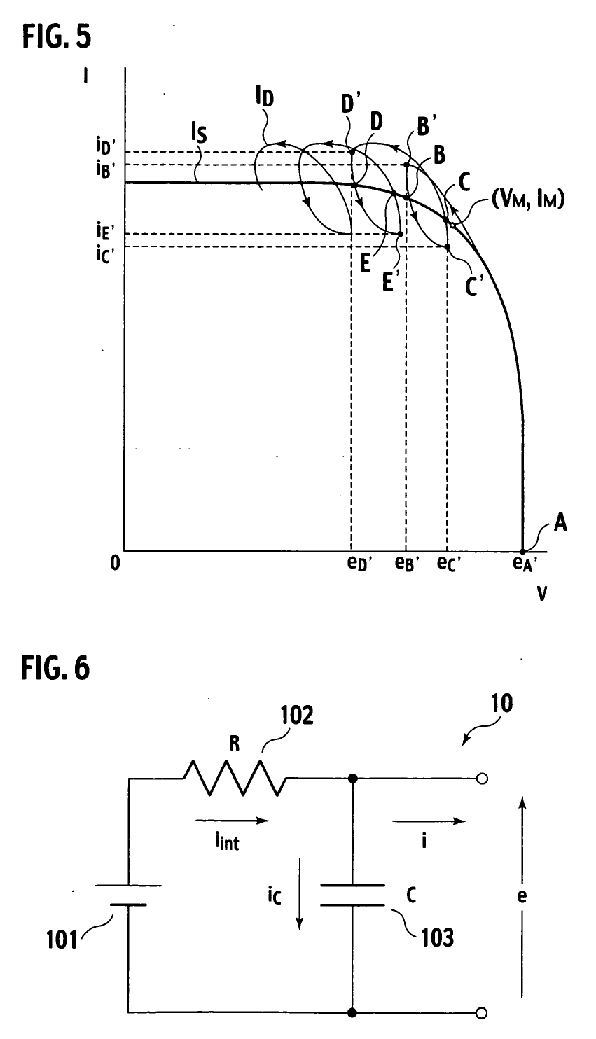

According to the above-described normal maximum power point tracking method, when the operating voltage is swept by high frequency, it becomes difficult to catch the real maximum power point by the hysteresis characteristic as shown in FIG. 2 as described above. Since the dynamic characteristic describes hysteresis loop as the sweep frequency is increased, the operating point is not converged near the maximum power point according to the normal MPPT method as shown in FIG. 5. In FIG. 5, on the static characteristic curve shown with the curve I_{S}, it should normally move from a point A as the operating point to a point B through the maximum power point P_{M}(V_{M}, I_{M}). However, when the dynamic characteristics shown by the curve I_{D} appears by sweeping the operating voltage at high speed, the operating point moves from the point A to the point B′. It then moves to a point C′, a point D′ and a point E′, the operating point is not converged to the maximum power point P_{M} and moves away from the maximum power point P_{M}.

This phenomenon is generated due to lifetime of the carrier in the solar battery, and the solar battery panel can be expressed by an equivalent circuit shown in FIG. 6. While the equivalent circuit of the static characteristic can be described using a net electromotive force 101 and an internal resistance R, in an equivalent circuit taking also dynamic characteristics into consideration, an equivalent capacitor C should be included therein. The Equivalent capacitor C is an element which becomes remarkable in the dynamic characteristic, and this causes time lag in frequency response and the hysteresis characteristic. Therefore, the equivalent capacitor makes it difficult to track the maximum power point. However, the hysteresis loop I_{D} in the dynamic characteristics surely intersects with the real static characteristic curve I_{S} at two points. It should be noted that the output current, the output voltage and the output power at the operating points such as the points B and C also reflect the real static characteristics, thus, it is possible to explore a correct maximum power point based on these values.

Current i_{c} passing through the equivalent capacitor C can be expressed by

$$[ Expression 1 ] \\ {i}_{c} = C \frac{ⅆ e ( t )}{ⅆ t} , \qquad ( 1 )$$

where e(t) is the output voltage of the solar battery panel 10. When i_{c} is 0, i.e., when de(t)/dt=0, influence of the equivalent capacitor C is eliminated, and it coincides with the static characteristic. It should be noted that the behavior of the time differentiation value de(t)/dt of the output voltage e(t) of the solar battery panel in the maximum power condition exploration, and found that even when the operating voltage is swept by the high frequency, it is possible to appropriately explore the maximum power point by detecting a time point at which the time differentiation value de(t)/dt becomes zero.

### FIRST EMBODIMENT

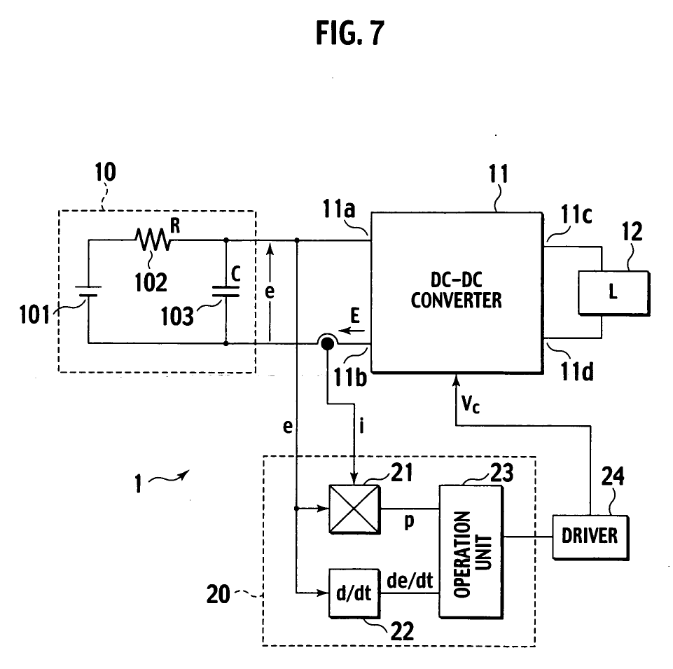

FIG. 7 shows a configuration of a photovoltaic power generator 1 according to the present invention. Generated power of a solar battery panel 10 is outputted to a load L through the DC-DC converter 11. A controller 20 detects output power p(t) and time differentiation value de(t)/dt of the output voltage based on the output voltage e(t) and the output current i(t) of the solar battery panel 10. The operation unit 20 detects a time point at which the de(t)/dt becomes substantially zero, and calculates output power p(t) at that time point. When sweep/perturbation voltage for exploring one operating point Vop is to be superimposed, the value of de(t)/dt becomes substantially zero at two points. As the time points are defined as t1 and t2 respectively (t1<t2), the operation unit 20 calculates the power variation Pdif from p (t1) and p(t2). At that time, in a case of (i) Pdif>0, the DC-DC converter 11 is controlled such that Vop is increased, and in a case of (ii) Pdif<0, the DC-DC converter 11 is feedback controlled such that Vop is reduced. It can be found that in a case where (iii) power variation Pdif is substantially zero, two points p1{e(t1), i(t1)} and p2{e(t2), i(t2)} are on the static curve of the V-I characteristic, and the maximum power point P_{M} exists between the points p1 and p2 on the static state. Hence, the DC-DC converter 11 is controlled by the controller 20 so that the Vop is held at that time.

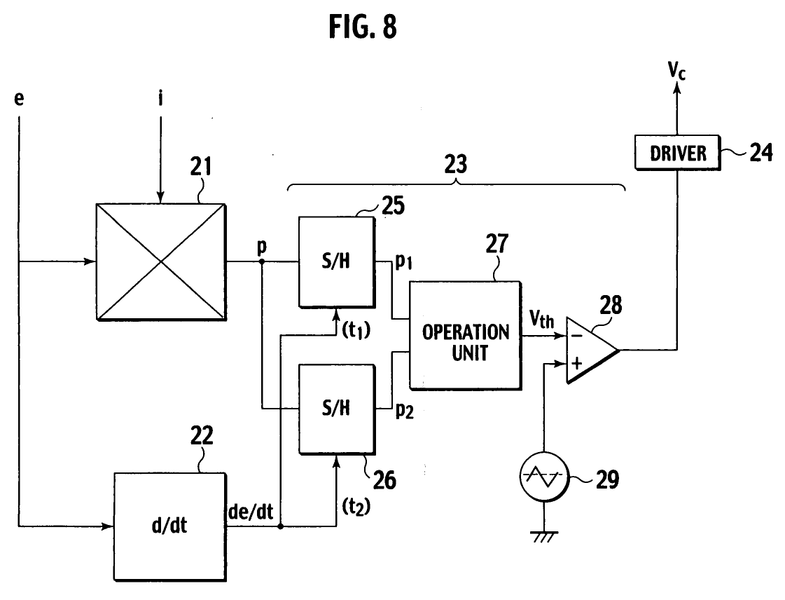

FIG. 8 shows a detailed configuration of the controller 20 of the photovoltaic power generator according to the first embodiment. Output voltage e and output current i of the solar battery panel 10 are inputted to the controller 20. The output voltage e is time-differentiated by a differentiator 22 and is outputted to an operation unit 23. The output voltage and the output current are multiplied by a multiplier 21 and are outputted to the operation unit 23 as output power p of the solar battery panel. The operation unit includes sample hold means 25 and 26 which detect time points t1 and t2 at which the time differentiation de/dt of the output voltage e substantially becomes zero. The first sample hold means 25 holds a value of output power p(t1) at the time point t1 at which de/dt substantially becomes zero when the voltage differentiation signal rises. The second sample hold means 26 holds a value of output power p(t2) at the time point t2 at which de/dt substantially becomes zero when the voltage differentiation signal falls.

An operator 27 obtains power variation Pdif by calculating a difference between the two power outputs p(t1) and p(t2) which are sample-held, and outputs a control signal Vth corresponding to the power variation to a comparator 28.

If the calculator 27 further integrates the differential calculation result and uses the same as the control signal Vth to the comparator, it is possible to realize more precise convergence to the optimum value (not illustrated).

The comparator 28 outputs the control signal Vc to the DC-DC converter 11 through a driver 24 based on the control signal Vth corresponding to the power variation Pdif, and controls the operating voltage Vop. That is, the operating voltage Vop is feedback controlled through the DC-DC converter 11 such that the power variation Pdif is substantially converged to zero, thereby exploring the maximum power point P_{M}.

As a result, the maximum power point P_{M} is swiftly be explored and the solar battery panel can always be operated at the maximum power point. In this embodiment, the comparator 28 compares a reference wave such as a triangular wave and a power variation Pdif as a threshold value, and outputs a control signal Vc for controlling the conduction ratio of switching of the DC-DC converter 11 to the DC-DC converter 11 in accordance with a result of the comparison. The DC-DC converter 11 controls the conduction ratio of switching, i.e., the electrical operating point such that the power is converged to the maximum power point P_{M} in accordance with the control signal Vc.

This embodiment can be adapted to a sweeping exploration in a frequency region over a few hundred Hz. Therefore, switching ripple component generated by the DC-DC converter 11 can be utilized for exploring the maximum power point. A person skilled in the art will understand that an oscillator may further be provided for periodically varying the conduction ratio of switching of the DC-DC converter 11.

According to this embodiment, the sample hold means 25 and 26 can always precisely catch the power value on the static characteristic even if the hysteresis loop appears. Therefore, it is possible to swiftly explore the maximum power point without using sweep frequency.

### SECOND EMBODIMENT

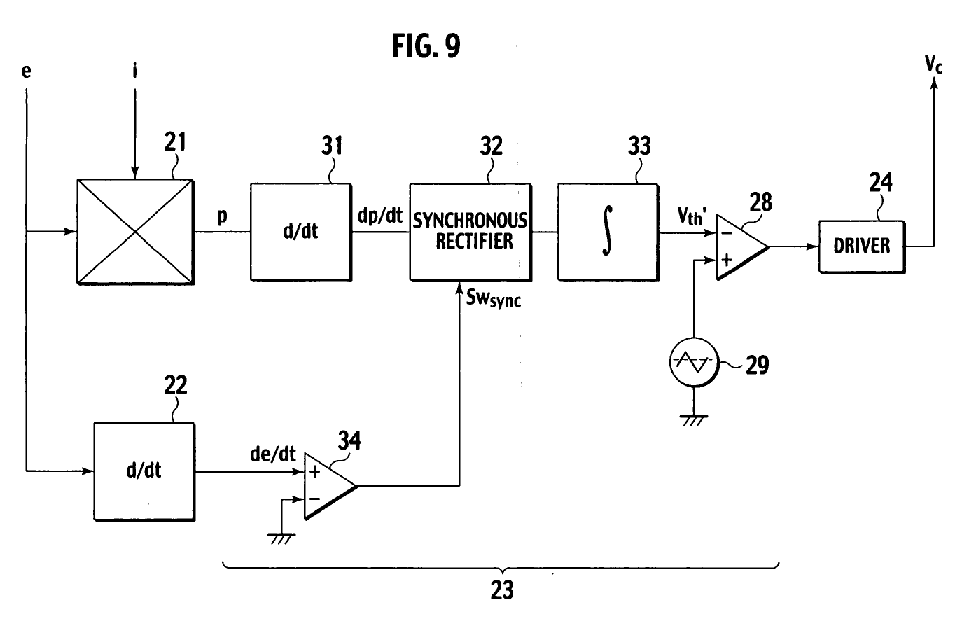

FIG. 9 shows a more detailed configuration of a controller of a photovoltaic power generator according to a second embodiment of the present invention. The second embodiment is different from the first embodiment only in the operation unit, other configuration thereof is the same as that of the first embodiment, and redundant explanation will be omitted. The second embodiment is different from the first embodiment in that while the photovoltaic power generator of the first embodiment obtains the power variation Pdif by the difference calculation in FIG. 7, the photovoltaic power generator of the second embodiment obtains the power variation Pdif using differential calculation.

In the second embodiment, time differentiation dp/dt of output power P of a solar battery panel is used for calculating the power variation Pdif. The power differentiation value dp/dt is definite integrated from the time point t1 to time point t2 wherein the voltage differentiation value substantially becomes zero at the time points t1 and t2. More specifically, when a voltage differentiation value is positive (de/dt>0)

$$[ Expression 2 ] \\ \begin{matrix}{\int }_{t 1}^{t 2} \frac{ⅆ p ( t )}{ⅆ t} ⅆ t = {[ p ( t ) ]}_{t 1}^{t 2} \\ = {[ P ( V ) ]}_{Vop - Δ V}^{Vop + Δ V} \\ = P ( {V}_{op} + Δ V ) - P ( {V}_{op} - Δ V ) \\ = {P}_{dif} ,\end{matrix} \qquad ( 2 )$$

and when voltage differentiation value is negative (de/dt<0)

$$[ Expression 3 ] \\ \begin{matrix}{\int }_{t 1}^{t 2} \frac{ⅆ p ( t )}{ⅆ t} ⅆ t = {[ p ( t ) ]}_{t 1}^{t 2} \\ = {[ P ( V ) ]}_{Vop + Δ V}^{Vop - Δ V} \\ = - {P}_{dif} .\end{matrix} \qquad ( 3 )$$

Therefore, when a polarity switching function h(t) is defined by

$$[ Expression 4 ] \\ h ( t ) = \{ \begin{matrix}ⅆ p ( t ) / ⅆ t & ( ⅆ e / ⅆ t > 0 ) \\ - ⅆ p ( t ) / ⅆ t & ( ⅆ e / ⅆ t < 0 )\end{matrix} , \qquad ( 4 )$$

the power variation Pdif is given by

$$[ Expression 5 ] \\ {P}_{dif} = {\int }_{t 1}^{t 2} h ( t ) ⅆ t . \qquad ( 5 )$$

The same result is obtained also by replacing the polarity of de/dt by the polarity (sign) of capacitor current ic by expression (1).

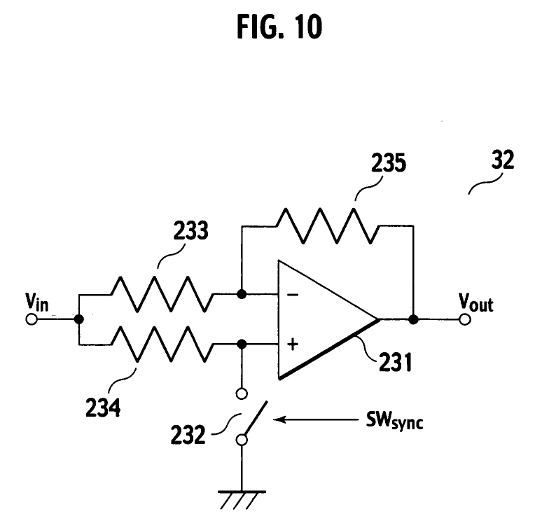

A controller 20 of this embodiment shown in FIG. 9 produces a control signal Vth′ corresponding to the power variation Pdif using the above-described method. That is, output power p(t) calculated by the multiplier 21 is time differentiated by a differentiator 31 and is definite integrated by an integrator through a sign switch. As a synchronous rectifier 32 as a sign switch, it is possible to use an amplifier which reverses a sign of an input signal by a control signal SWsync as shown in FIG. 10 and outputs the same. Input terminals of an amplifier 231 are equal to input voltage Vin when a control switch 232 is OFF, current does not pass through resistors 233 and 235 and non-inverting amplification is preformed. Further, since the inverting input (−) of the amplifier 231 becomes equal to ground potential when the control switch 232 is ON, inverting amplification is realized. As a result, the synchronous rectifier 32 switches a sign of input signal Vi in synchronization with the control signal SWsync and outputs the same.

If voltage differentiation value de/dt outputted from the differentiator 22 is inputted to a synchronous rectifier 32 as a control signal SWsync through a comparator 34, the synchronous rectifier 32 performs an operation of the expression (4) in accordance with a sign of the control signal. A result of the calculation is definite integrated between the time points t1 and t2 at which de/dt becomes equal to 0 in accordance with the expression (5). As a result, like the first embodiment, even when hysteresis loop appears, power variation Pdif is calculated based on the static characteristic, and maximum power condition is swiftly be explored. Since the integration calculation is also averaging of the gradient dp/dt at each point between the time points t1 and t2, the integration calculation is less subject to noise.

In this embodiment, the time point t2 is defined as the time point t1 in the next definite integration calculation, the definite integration is repeated. Since respective results of the definite integration calculations are accumulated and inputted to the comparator 28, the integrator 33 carries out sequentially calculated definite integration and totalizing operations of the results. Therefore, it is required only that the integrator 33 has the function of continuously time integrating input signals. An approximation integration circuit, a low pass filter or the like can be employed instead of the integrator.

### THIRD EMBODIMENT

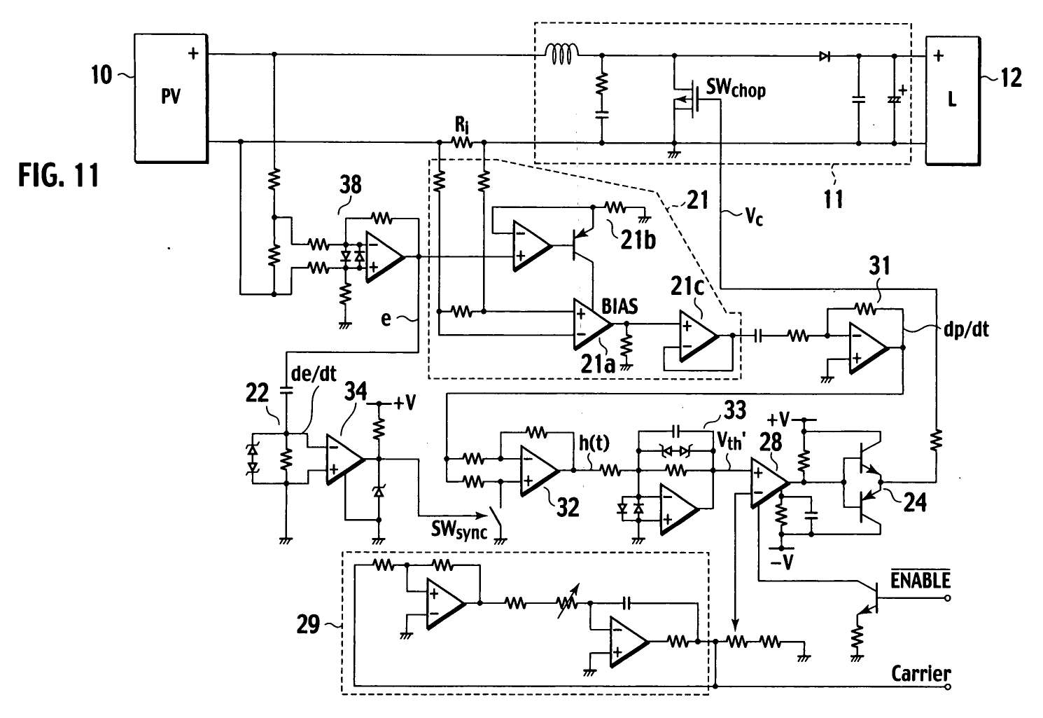

FIG. 11 shows a photovoltaic power generator of a third embodiment in which the configurations of the present invention shown in FIGS. 7 and 9 are realized. Like the second embodiment, the power variation Pdif is obtained using differentiation calculation.

According to the photovoltaic power generator of the present embodiment shown in FIG. 11, output voltage e of the solar battery panel 10 is detected by a voltage amplifier 38. Output current i of the solar battery panel 10 is detected by a detection resistor Ri, and is amplified by a transconductance amplifier 21a. The output voltage e is converted into current corresponding to the voltage e by a current source 21b, and is supplied as a bias of the transconductance amplifier 21a. As a result, the current i is multiplied by the voltage e, and a power value p is outputted from a buffer 21c. The power value p is time differentiated by a differentiator 31 and is inputted to the synchronous rectifier 32. On the other hand, the output voltage e is time differentiated by the differentiator 22, and is compared and determined by a comparator 34, and is inputted to a control terminal of the synchronous rectifier 32, thereby carrying out calculation of expression (4). As a result, the integrator 33 sequentially carries out calculation of expression (5) with respect to the output h(t) of the synchronous rectifier. The comparator 28 compares and determines the integration results while using a triangular wave outputted from an oscillator 29 as a threshold value, and controls through a driver 24 a conduction ratio of a switching element SWchop of the DC-DC converter. The integrator 33 has an analogue integration circuit which integrates the sequentially calculated time definite integration and results thereof, produces the control signals Vth′ corresponding to the power variation Pdif, and outputs the same to the comparator 28.

In this embodiment, like the second embodiment, an integration range (t1≦t≦t2) of the definite integration expressed by the expression (5) is determined based on the voltage differentiation value de/dt. Therefore, since the polarity of the h(t) is switched over after the time point t2, the time point t2 is newly defined as a time point t1 in a new integration calculation, de/dt cuts across zero and definite integration is carried out until the time point t2 at which its sign is switched over. An electrical operating point is periodically varied and dp/dt is time integrated from the moment t1 at which a time differentiation value of the output voltage becomes zero to the moment t2 at which the time differentiation value again becomes zero. As a result, a power difference on the two points, i.e., points Pa and Pb on the static characteristic can be obtained. A result of integration for integration while changing the polarity of dp/dt in synchronous with a change in sign of the time differentiation value de/dt of the output voltage always shows Pb-Pa, and even when hysteresis loop is generated, the power difference on the two points on the static characteristic can be obtained. Therefore, it is possible to explore the maximum power point. Since such operations are sequentially carried out, it is possible to swiftly move the operating point of the solar battery panel 10 to the maximum power point P_{M}.

In this embodiment, like the other embodiments, a switching ripple component generated by the DC-DC converter 11 can be utilized as a perturbation of electrical operating point for exploration. This is because that the exploration of the maximum power condition has a sufficient response to the variation speed of the switching ripple component according to the photovoltaic power generation of this embodiment. It is also possible to produce the operating point variation for exploration by means for periodically varying the conduction ratio of the switching element SWchop without using the switching ripple component.

Adaptation to Exploration Speed

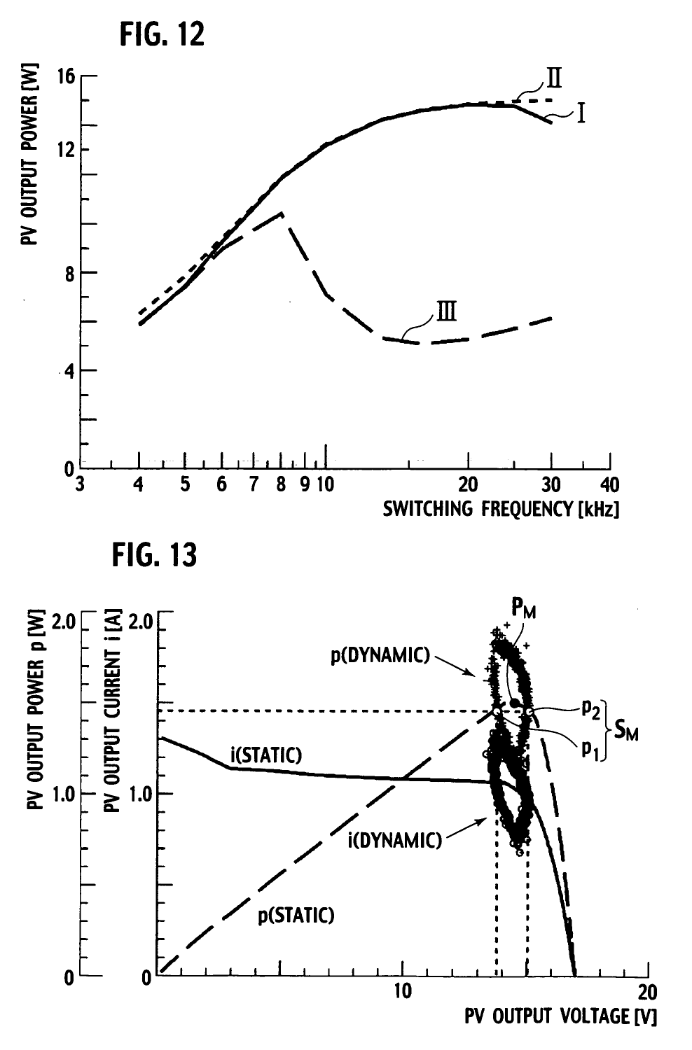

FIG. 12 shows a result obtained by executing exploration of maximum power condition of the solar battery panel by the photovoltaic power generator of this embodiment. A curve II shows an ideal frequency characteristic of the output of the solar battery panel when a switching conduction ratio is manually adjusted in each switching frequency and the maximum power condition is explored. A curve III shows a result obtained by a conventional maximum power exploring method. In this result, it is found that it failed to explore the appropriate maximum power condition in a high frequency region (6 kHz or higher). Whereas, according to the photovoltaic power generator of this embodiment, as shown with a curve I, even when the exploration speed is in a high frequency region and the dynamic characteristic of the solar battery panel generates a remarkable hysteresis loop, a result corresponding to ideal frequency characteristic is obtained.

FIG. 13 shows a result of exploration of the operating point when the switching frequency is set to 20 kHz in the photovoltaic power generator of this embodiment. As shown in the figure, the exploration is appropriately executed and static characteristic of the solar battery panel is explored from dynamic characteristic response of the solar battery panel at the time point of de/dt=0 (or ic=0). As a result, the exploring range is converged to a portion between the operating points p1 and p2 (exploration region S_{M}) in the vicinity of the maximum power point P_{M}.

According to the photovoltaic power generator of the embodiment, even when the amount of generated power of the solar battery panel is abruptly varied, it is possible to precisely explore the maximum power point which changes within 1 ms.

Although the invention has been described above by reference to certain embodiments of the invention, the invention is not limited to the embodiments described above. Modifications and variations of the embodiments described above will occur to those skilled in the art, in light of the teachings. For example, while in the embodiments, the power differentiation value detector and the voltage differentiator are constituted of a combination of a plurality of detectors and calculators, a detector, which directly obtains differentiation values for power and voltage, can be used.

This application claims benefit of priority under 35USC §119 to Japanese Patent Applications No. 2003-380566, filed on Nov. 10, 2003, the entire contents of which are incorporated by reference herein.

1-9. (canceled)

10. A photovoltaic power generator providing power generated by a solar battery panel through a DC-DC converter, wherein
a maximum power condition of the solar battery panel is explored by controlling the DC-DC converter based on an output power of the solar battery panel at a time point at which a time differentiation value of the output voltage of the solar battery panel substantially becomes zero.

11. The photovoltaic power generator according to claim 10, wherein
the maximum power condition of the solar battery panel is explored based on a difference between a first output power of the solar battery panel at a first time point and a second output power of the solar battery panel at a second time point in which the time differentiation value of the output voltage becomes substantially zero at the first and second time points.

12. The photovoltaic power generator according to claim 11, wherein
the difference between the first output power and the second output power is calculated based on values obtained by integrating the time differentiation of the output power of the solar battery panel from the first time point to the second time point.

13. The photovoltaic power generator according to claim 10, wherein the controlling of the DC-DC converter is that of switching conduction ratio.

14. The photovoltaic power generator according to claim 11, wherein the controlling of the DC-DC converter is that of switching conduction ratio.

15. The photovoltaic power generator according to claim 12, wherein the controlling of the DC-DC converter is that of switching conduction ratio.

16. The photovoltaic power generator according to claim 11, wherein a switching ripple of the DC-DC converter is used as a sweep signal for exploring the maximum power condition.

17. The photovoltaic power generator according to claims 12, wherein a switching ripple of the DC-DC converter is used as a sweep signal for exploring the maximum power condition.

18. The photovoltaic power generator according to claim 10, wherein
the time point at which the time differentiation value of the output voltage of the solar battery panel substantially becomes zero is determined as a time point at which a current passing through an equivalent capacitor of the solar battery panel substantially becomes zero.

19. The photovoltaic power generator according to claim 11, wherein
the time point at which the time differentiation value of the output voltage of the solar battery panel substantially becomes zero is determined as a time point at which a current passing through an equivalent capacitor of the solar battery panel substantially becomes zero.

20. The photovoltaic power generator according to claim 12, wherein
the time point at which the time differentiation value of the output voltage of the solar battery panel substantially becomes zero is determined as a time point at which a current passing through an equivalent capacitor of the solar battery panel substantially becomes zero.

21. A control method of a photovoltaic power generator providing power generated by a solar battery panel through a DC-DC converter, comprising:
detecting a time point at which a time differentiation value of an output voltage of the solar battery panel substantially becomes zero; and
controlling the DC-DC converter based on the output power of the solar battery panel at the detected time point to explore the maximum power condition of the solar battery panel.

22. The control method of the photovoltaic power generator according to claim 21, wherein
in the procedure of controlling the DC-DC converter, the DC-DC converter is controlled based on a difference between a first output power of the solar battery panel at the first time point at which a time differentiation value of the output voltage substantially becomes zero and a second output power of the solar battery panel at the second time point at which a time differentiation value of the output voltage substantially becomes zero.

23. The control method of the photovoltaic power generator according to claim 22, wherein a switching ripple of the DC-DC converter is used as a sweep signal for exploring the maximum power condition.

24. The control method of the photovoltaic power generator according to claim 23, wherein a switching ripple of the DC-DC converter is used as a sweep signal for exploring the maximum power condition.
